(19) United States
(12) Patent Application Publication
(10) Pub. No.: US 2023/0121222 A1
(43) Pub. Date: Apr. 20, 2023

(54) Method and Apparatus for Demonstrating a Scientific Principle

(71) Applicant: Timothy Ryan Rogers, Fayetteville, AR (US)

(72) Inventor: Timothy Ryan Rogers, Fayetteville, AR (US)

(21) Appl. No.: 17/961,813

(22) Filed: Oct. 7, 2022

Related U.S. Application Data
(60) Provisional application No. 63/256,944, filed on Oct. 18, 2021.

(51) Int. Cl. G09B 23/10

(52) U.S. Cl. CPC G09B 23/10

(57) ABSTRACT

The present disclosure provides apparatus and methods for demonstrating the definition of entropy and distinguishing it from the concept of disorder by simulating a canonical ensemble. The apparatus required for the method is easy to manufacture and the demonstration is simple to carry out, making the demonstration readily available to any educational facility wishing to improve the understanding of this fundamental principle of modern science.

### FIELD OF INVENTION

The present invention relates generally to scientific demonstrations. More specifically, the present invention relates to methods and apparatus for demonstrating a distinction between the concepts of entropy and disorder.

### BACKGROUND

The principle of entropy is one that is commonly misunderstood due to the lack of intuitive demonstrations available for explaining it. One particular misconception that is frequently applied to entropy is that it is the same as, or at least causally related and proportional to disorder. This is not true. While entropy is frequently correlated with disorder, the relationship is not causal; rather, entropy is quantitatively defined by the number of energetic degrees of freedom of a system.

Referring to the second law of thermodynamics, it is stated that the total entropy of an isolated/closed system (the thermal energy per unit temperature that is unavailable for doing useful work) can never decrease, it can only stay the same or increase. This fundamental law of science is often misquoted as meaning that the disorder of an isolated system can never decrease, and must increase in response to an increase in entropy or that an increase in entropy is equivalent to an increase in disorder.

Given the importance of the second law of thermodynamics in scientific education, it would be highly beneficial to have a demonstrative method and apparatus for intuitively and unequivocally clearing these misconceptions and facilitating teaching based on the actual definition of entropy. It is within this context that the present invention is provided.

### SUMMARY

The present disclosure provides apparatus and methods for demonstrating the concept of entropy and distinguishing it from the concept of disorder. The apparatus required for the method is easy to manufacture and the demonstration is simple to carry out, making the demonstration readily available to any educational facility wishing to improve the understanding of this fundamental principle of modern science.

Thus, according to one aspect of the present disclosure there is provided apparatus for demonstrating a scientific principle, the apparatus comprising: a transparent closed container having a removable lid, the container forming an internal volume having smooth regular walls; and one or more sets of particle elements, each particle element being polyhedral in shape, occupying a volume substantially lower than the internal volume of the closed container, and being formed of a hard material which is resistant to deformation, and each particle element in a set being identical to the other particle elements in the respective set.

It is important that the total volume of the one or more sets of particle elements is less than the internal volume of the closed container, but that the difference between the total volume of the particle elements and the internal volume of the closed container is small.

In some embodiments, the apparatus comprises two or more sets of particle elements of different polyhedral shapes or colors.

The closed container may be configured with one or more variable dimensions to allow the container shape or internal volume to be varied.

In some embodiments, the closed container is cuboid in shape. In other embodiments, the closed container is cylindrical in shape.

In some embodiments, the total volume of the one or more sets of particle elements is between 40% and 60% of the internal volume of the closed container.

In some embodiments, the apparatus further comprises an agitator element mechanically connected to the closed container and configured to agitate the container about multiple axes to simulate a spontaneous process in a canonical ensemble.

According to another aspect of the present disclosure, there is provided a method for demonstrating a scientific principle, the method comprising the steps of:

a) providing a transparent closed container forming a constant internal volume having smooth regular walls.

b) filling the closed container with one or more sets of particle elements such that the particle elements rest against one another in a disordered state within the closed container, each particle element being polyhedral in shape, occupying a volume substantially lower than the internal volume of the closed container, and being formed of a hard material which is resistant to deformation, and each particle element in a set being identical to the other particle elements in the respective set.

c) agitating the closed container about multiple axes with sufficient force to displace the particle elements within the closed container and thereby simulating a spontaneous process in a canonical ensemble, the volume of the container remaining fixed during the agitation.

Once again, it is important that the total volume of the one or more sets of particle elements is less than the internal volume of the closed container, but the difference between the total volume of the particle elements and the internal volume of the closed container is small.

### BRIEF DESCRIPTION OF THE DRAWINGS

Various embodiments of the invention are disclosed in the following detailed description and accompanying drawings.

FIG. 1A and FIG. 1B illustrate an isometric view of a first example configuration of a closed container filled with particle elements which transition from a disordered state before agitation to a more ordered state following agitation.

FIG. 2A and FIG. 2B illustrate an isometric view of a second example configuration of a closed container filled with particle elements which transition from a disordered state before agitation to a more ordered state following agitation.

FIG. 3A and FIG. 3B illustrate an isometric view of a third example configuration of a transparent closed container filled with particle elements which transition from a disordered state before agitation to a more ordered state following agitation.

FIG. 4 illustrates a flow diagram of a set of steps comprising the disclosed demonstrative method.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

As mentioned above, the total entropy of a closed system cannot decrease. Indeed, for a spontaneous process involving only non-interacting particles in a closed system with no external forces, the total entropy must always increase. This can be shown from base principles by considering the Helmholtz free energy, A, which measures the useful work obtainable from a canonical ensemble, which is calculated by:

A=U−T·S

Where U is the internal energy of the system, T is the absolute temperature of the system, and S is the total entropy of the system. When the system comprises only non-interacting particles with no outside forces acting on them, there will be no change in U during any process, and the change in Helmholtz energy for any process can be simply calculated as

ΔA=−TΔS

Thus, for a spontaneous process, where the Helmholtz free energy of the system decreases and ΔA is negative, ΔS must be positive, implying that the entropy of the final state is greater than in the initial state.

The present disclosure provides methods and apparatus based on the above principles, which simulate a spontaneous event in a closed system of hard, non-interacting particles approximating a canonical ensemble (i.e. an event which must cause an increase in entropy) where disorder of the system visibly decreases, proving that entropy and disorder are not the same in an intuitive manner. At the same time, the change in the system is explainable on the basis that the probability of observing the final state is greater than that of the initial state, or equivalently that the number of energetic states accessible to the final state is greater than to the initial state, thus facilitating an intuitive understanding of the actual definition of entropy.

This is achieved by agitating one or more sets of hard geometric objects (that can be approximated as non-interacting particles) within an enclosed container, where the objects are densely packed in the container such that an increase in order of the particles creates the space for additional degrees of freedom by allowing more translational movement between the particles.

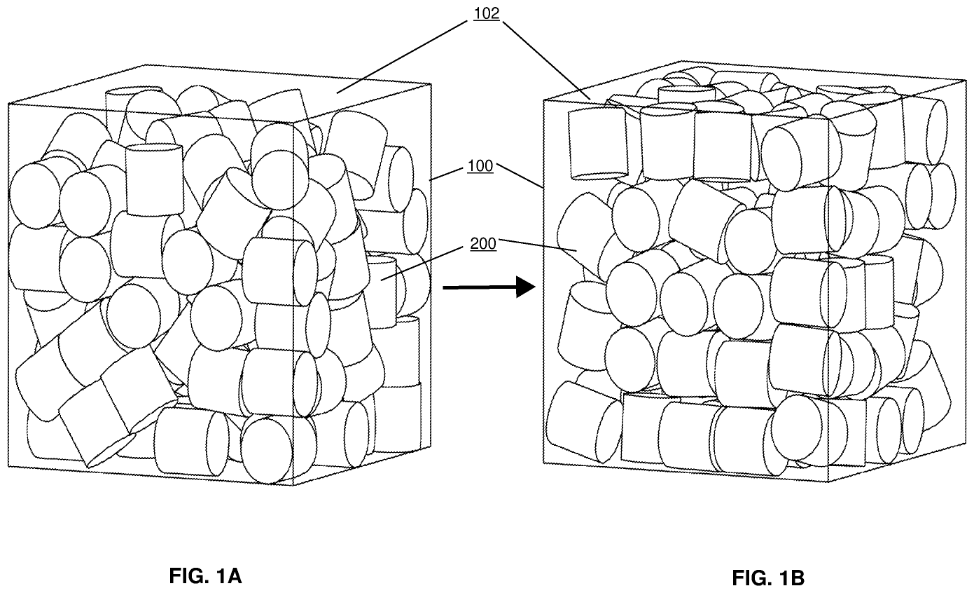

Thus, referring to FIG. 1A and FIG. 1B, an isometric view of a first example configuration is shown of a transparent closed container 100 having a removable lid 102 and which is filled with particle elements 200.

FIG. 1A shows the container 100 prior to an agitation simulating a spontaneous event within the system and FIG. 1B shows the container 100 subsequent to the agitation. As can be seen, the particle elements 200 begin in a relatively disordered state in FIG. 1A and transition to a more ordered state in FIG. 1B.

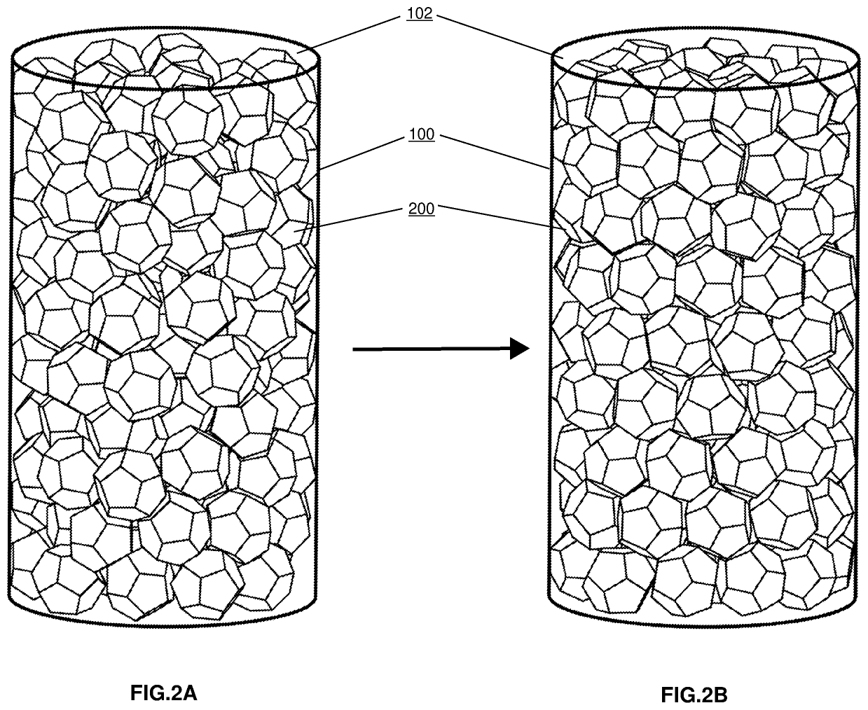

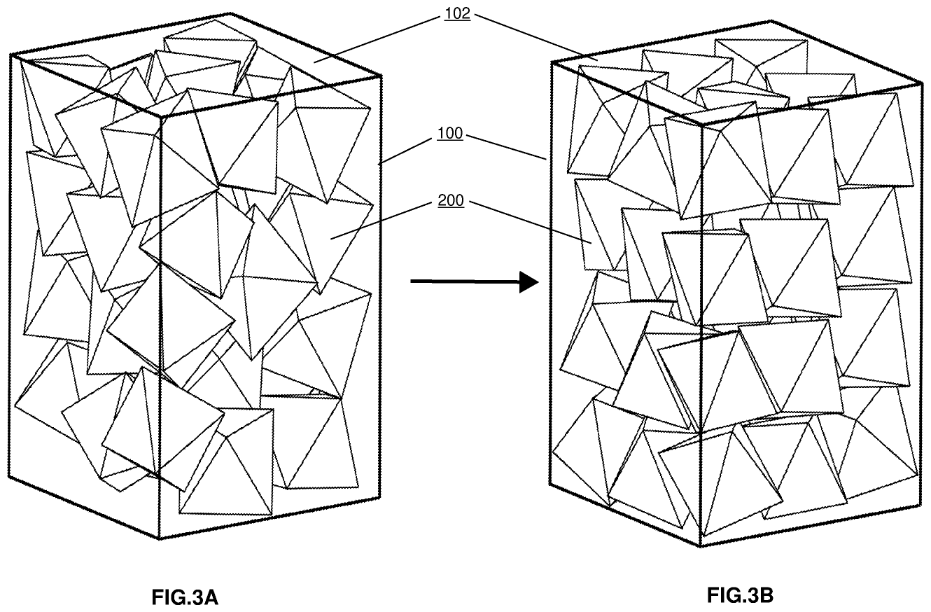

The transparent closed container is shown as a cube but can in fact be any shape, including the cylinder shape shown in FIGS. 2A and 2B and the cuboid shape shown in FIG. 3A and FIG. 3B. The container may even be one that can change shape or internal volume in-between demonstrations, however it should be constructed so as to remain at constant volume during each demonstration to maintain the thermodynamic principles being simulated.

It is helpful if the container 100 has smooth, regular walls as such features will facilitate a visually obvious disorder to order transition during the demonstration. However, such features are not necessitated by the thermodynamic conditions being simulated, so that the present invention is not limited by the shape or characteristics of the container 100, notwithstanding its rigidity and constancy of volume.

The particle elements 200 can similarly be of any shape, although symmetrical polyhedra are better for demonstrating visible order as the alignment can be seen easily. Shapes can include the cylinders shown in shown in FIG. 1A and FIG. 1B, the 12-sided polyhedra shown in FIG. 2A and FIG. 2.2B, and the 8-sided polyhedra shown in FIG. 3A and FIG. 3B. Discs, rods, cones, and any other kind of shape can be used. It is important however that the particle elements 200 are always formed of a hard material to approximate non-interacting particles.

The particle elements 200 should be significantly smaller in volume than the internal volume of container 100 so that a high enough number of particles can be arranged within that the principles at play can be visually recognised.

Furthermore, in order for the demonstration to work properly, the container 100 must be filled with enough particle elements 200 that it is densely packed, and a transition to a more ordered state will increase the translational degrees of freedom of the polyhedral particle elements 200. For example, an optimal total volume of the particle elements 200 may frequently be greater than 40% of the total internal volume of the container.

The apparatus may be provided as a kit with one or more different closed containers 100 and one or more sets of particle elements 200. For example, different shapes and colours of particles can be provided to allow educational facilities to enable students to investigate different facets of the simulated spontaneous event—the relationship between visible order and different shapes and/or combinations of shapes, the extent to which shape effects change in order, effects on order due to the size and/or shape of container 100, and the amount of mixing that occurs during agitation for different shapes can all be examined with sets of differently coloured and shaped hard particles and different containers 100. Even principles such as crystallisation can be investigated to an extent.

The apparatus may even be provided with an agitator element mechanically connected to the closed container and configured to agitate the container about multiple axes to simulate a spontaneous process in a canonical/NVT ensemble. In general, the agitating motion can be performed by a demonstrator simply holding and shaking the container (they must ensure that the agitation is performed about all translational and rotational axes in order to properly simulate an isotropic particle environment in a closed system where the effects of gravity are negligible; vigorous rotation about each axis removes gravitational bias and translational agitation simulates the thermodynamic temperature) however it may be convenient in some contexts to be able to agitate the container without manual effort.

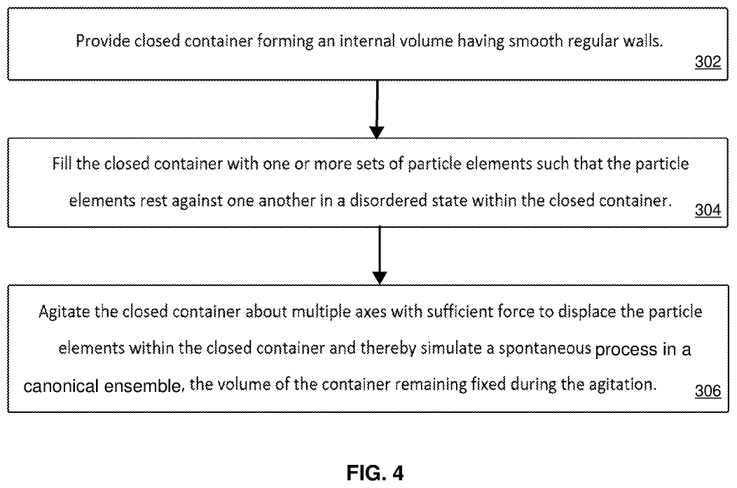

Referring to FIG. 4, a flow diagram of a set of steps comprising the disclosed demonstrative method is shown.

A first step in the method 302 involves providing a transparent closed container forming a constant internal volume having smooth regular walls for simulating a closed system where the Helmholtz free energy approximation applies as mentioned above.

A second step in the method 304 involves filling the closed container with one or more sets of particle elements such that the particle elements rest against one another in a disordered state within the closed container. Without loss of generality or affecting the thermodynamic principles being simulated, this step 304 can be repeated as needed to achieve an initial state in which the particle elements are visually disordered.

As mentioned above, each particle element is polyhedral in shape, occupying a volume substantially lower than the internal volume of the closed container, and being formed of a hard material which is resistant to deformation.

It is also important that the total volume of the one or more sets of particle elements is less than the internal volume of the closed container, but the difference between the total volume of the particle elements and the internal volume of the closed container is small.

These conditions allow the non-interacting approximation to also be applied, and the densely packed arrangement will ensure that spatial order of the system increases when its entropy increases due to the particles blocking degrees of translational freedom in the disordered state.

Each particle element in a set is identical to the other particle elements in the respective set. This helps with visual recognition of order and disorder.

A third and final step in the method 306 involves agitating the closed container about multiple axes with sufficient force to displace the particle elements within the closed container and thereby simulating a spontaneous process in a canonical ensemble, the volume of the container remaining fixed during the agitation. The entropy of the final state of the particles must have increased due to the conditions in which the “spontaneous event” occurred. Therefore if the final state of the system is more visibly ordered, the synonymity of “order” and “entropy” is thereby disproved unequivocally.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the method and apparatus have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. Apparatus for demonstrating a scientific principle, the apparatus comprising:
a transparent closed container having a removable lid, the container forming an internal volume having smooth regular walls; and
one or more sets of particle elements, each particle element being polyhedral in shape, occupying a volume substantially lower than the internal volume of the closed container, and being formed of a hard material which is resistant to deformation, and each particle element in a set being identical to the other particle elements in the respective set;
wherein the total volume of the one or more sets of particle elements is less than the internal volume of the closed container, but the difference between the total volume of the particle elements and the internal volume of the closed container is small.

2. Apparatus for demonstrating a scientific principle according to claim 1, wherein the apparatus comprises two or more sets of particle elements of different polyhedral shapes.

3. Apparatus for demonstrating a scientific principle according to claim 1, wherein the closed container is configured with one or more variable dimensions to allow the internal volume to be varied.

4. Apparatus for demonstrating a scientific principle according to claim 1, wherein the closed container is cuboid in shape.

5. Apparatus for demonstrating a scientific principle according to claim 1, wherein the closed container is cylindrical in shape.

6. Apparatus for demonstrating a scientific principle according to claim 1, wherein the total volume of the one or more sets of particle elements is 40% or more of the internal volume.

7. Apparatus for demonstrating a scientific principle according to claim 1, wherein the apparatus further comprises an agitator element mechanically connected to the closed container and configured to agitate the container about multiple axes to simulate a spontaneous process in a canonical ensemble.

8. Method for demonstrating a scientific principle, the method comprising the steps of:
a) providing a transparent closed container forming an internal volume having smooth regular walls;
b) filling the closed container with one or more sets of particle elements such that the particle elements rest against one another in a disordered state within the closed container, each particle element being polyhedral in shape, occupying a volume substantially lower than the internal volume of the closed container, and being formed of a hard material which is resistant to deformation, and each particle element in a set being identical to the other particle elements in the respective set; and
c) agitating the closed container about multiple axes with sufficient force to displace the particle elements within the closed container and thereby simulating a spontaneous process in a canonical ensemble, the volume of the container remaining fixed during the agitation;
wherein the total volume of the one or more sets of particle elements is less than the internal volume of the closed container, but the difference between the total volume of the particle elements and the internal volume of the closed container is small.

9. Method for demonstrating a scientific principle according to claim 8, wherein the closed container is filled with two or more sets of particle elements of different polyhedral shapes.

10. Method for demonstrating a scientific principle according to claim 8, wherein the closed container is configured to change in shape or dimensions in between demonstrations.

11. Method for demonstrating a scientific principle according to claim 8, wherein the closed container is cuboid in shape.

12. Method for demonstrating a scientific principle according to claim 8, wherein the closed container is cylindrical in shape.

13. Method for demonstrating a scientific principle according to claim 8, wherein the total volume of the one or more sets of particle elements is 40% or greater of the internal volume of the container.
